(19) United States
(12) Patent Application Publication
(10) Pub. No.: US 2026/0212786 A1
(43) Pub. Date: Jul. 23, 2026

(54) Lighted Hand Gesture Signage

(71) Applicant: Ted DeCosmo, Davie, FL (US)

(72) Inventor: Ted DeCosmo, Davie, FL (US)

(21) Appl. No.: 19/030,607

(22) Filed: Jan. 17, 2025

(51) Int. Cl. G09F 13/18; G09F 13/00; G09F 21/04

(52) U.S. Cl. CPC G09F 13/18; G09F 13/005; G09F 21/0485; G09F 2013/184

(57) ABSTRACT

The lighted hand gestures signage includes an outline structure of an outstretched human hand with four fingers and a thumb; a first string of lights strung on the structure on a perimeter of the outline shape of the human hand for a hand gesture display; and a controller configured to control a power source for the first string of lights and control its on-time. The disclosed device includes a wireless “ON” button pressed once to wave, twice for the peace sign, and so on for other disclosed gestures.

### BACKGROUND OF THE INVENTION

Hand signal courtesies such as a thank you for letting another driver pass and for letting them come into one’s lane are part of safe and friendly driving. Notably, drivers of the Jeep brand are known for extending hand signal courtesies to other Jeep brand drivers including waving as they pass each other or as they pass going in opposite directions. However, it is unsafe to take one’s hand off a steering wheel and to be distracted from driving.

There has therefore been a long felt need for a device which allows driving enthusiasts to signal courtesies to each other while driving safely.

### SUMMARY OF THE INVENTION

The lighted hand gestures signage includes an outline structure of an outstretched human hand with four fingers and a thumb; a first string of lights strung on the structure on a perimeter of the outline shape of the human hand for a hand gesture display; and a controller configured to control a power source for the first string of lights and control its on-time. The disclosed device includes a wireless “ON” button pressed once to wave, twice for the peace sign, and so on for other disclosed gestures.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a top elevation depiction of the lighted hand gestures signage in accordance with an embodiment of the present disclosure.

FIG. 2 is a side depiction of the lighted hand gestures signage in accordance with an embodiment of the present disclosure.

Throughout the description, similar and same reference numbers may be used to identify similar and same elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the claims.

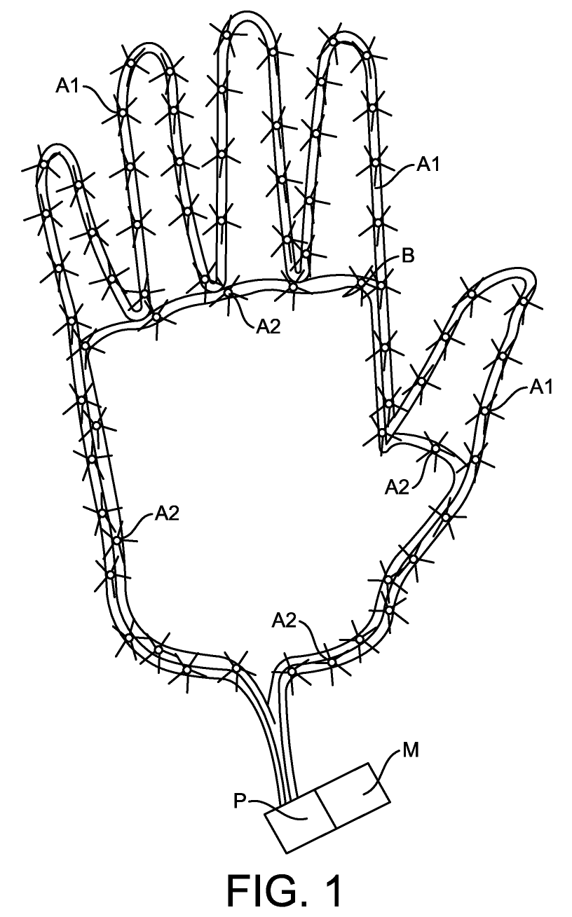

FIG. 1 is top elevation depiction of the Lighted Hand Gestures Signage in accordance with an embodiment of the present disclosure. The depiction includes the clear plastic tubing A1 and A2 comprising LED (light emitting diodes) therein controllable from an attached button on a steering wheel of a vehicle and by a controlling circuit M. A power source P supplies electrical power to the disclosure by the vehicles internal power and/or a direct current battery pack.

There are two strings A1 and A2 in this depiction but other multiple lights displaying other gestures are included in embodiments of the present disclosure. The supporting structure B in the present embodiment is a black weather proof foam but other support structures both inherent to the vehicle and external to it are also included in the disclosure. In the case where the support structure is a substrate type as a foam board or a plastic-silicon composite, an adhesive is applied to one or both sides to enable it applied to a window, mirror or other part of the vehicle both inside and outside.

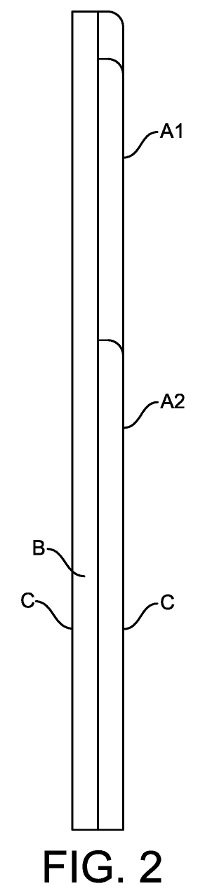

FIG. 2 is a side depiction of the Lighted Hand Gestures Signage in accordance with an embodiment of the present disclosure. The side depiction includes the lit strings A1 and A2, the backing B and the adhesive C.

Embodiments of the disclosure include a black backing with both a front side and the backside, a rigid structure is rigid and comprises a weather proof foam, and a flexible structure comprising a silicon and plastic composite. The front side and a backside of the structure both comprise an adhesive.

Alternatively, the structure is a wire frame of the outline shape in order to be disposed on a side view vehicle mirror, wherein a vehicle mirror itself provides the structure for the first string of lights gesture display. A vehicle window itself also provides the structure for the first string of lights gesture display.

The first string of lights comprises LED (light emitting diodes) inside a plastic tube of LED (light emitting diode) lights. The first string of lights is configured to light up a hand wave gesture of all four fingers and a thumb outstretched. A second string of lights is configured to light up a peace sign gesture of the first and the second fingers. A third string of lights configured to light up a gesture of an outstretched thumb and little finger.

A controller electronic circuit controls a blinking on-time for the first string of lights, wherein the controller controls the power and on-time to a plurality of light strings in addition to the first string of lights. The controller electronic circuit also controls an on-time sequence of a first gesture and a plurality of gestures in series. The controller electronic circuit also controls the power source and the on-time through a single push button switch which completes a circuit including the first string of lights and the power source.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents to be included by reference in a non-provisional utility application.

What is claimed is:

1. A lit signage comprising a structure comprising an outline shape of an outstretched human hand with four fingers and a thumb; a first string of lights strung on the structure on a perimeter of the outline shape of the human hand for a hand gesture display; and a controller configured to control a power source for the first string of lights and control its on-time.

2. The lit signage of claim 1, wherein the structure is a black backing with both a front side and the backside.

3. The lit signage of claim 1, wherein the structure is rigid and comprises a weather proof foam.

4. The lit signage of claim 1, wherein the structure is flexible and comprises a silicon and plastic composite.

5. The lit signage of claim 1, wherein a front side and a backside of the structure both comprise an adhesive.

6. The lit signage of claim 1, wherein the structure is a wire frame of the outline shape in order to be disposed on a side view vehicle mirror.

7. The lit signage of claim 1, wherein a vehicle mirror itself provides the structure for the first string of lights gesture display.

8. The lit signage of claim 1, wherein a vehicle window itself provides the structure for the first string of lights gesture display.

9. The lit signage of claim 1, wherein the first string of lights comprises LED (light emitting diodes).

10. The lit signage of claim 1, wherein the first string of lights comprise a plastic tube of LED (light emitting diode) lights.

11. The lit signage of claim 1, wherein the first string of lights is configured to light up a hand wave gesture of all four fingers and a thumb outstretched.

12. The lit signage of claim 1, further comprising a second string of lights configured to light up a peace sign gesture of the first and the second fingers.

13. The lit signage of claim 1, further comprising a third string of lights configured to light up a gesture of an outstretched thumb and little finger.

14. The lit signage of claim 1, wherein the controller controls a blinking on-time for the first string of lights.

15. The lit signage of claim 1, further comprising a plurality of light strings in addition to the first string of lights strung on the backing.

16. The lit signage of claim 1, wherein the controller controls the power and on-time to a plurality of light strings in addition to the first string of lights.

17. The lit signage of claim 1, wherein the controller controls an on-time sequence of a first gesture and a plurality of gestures in series.

18. The lit signage of claim 1, wherein the controller controls the power source and the on-time through a single push button switch which completes a circuit including the first string of lights and the power source.
